(19) United States
(12) Patent Application Publication
(10) Pub. No.: US 2023/0391266 A1
(43) Pub. Date: Dec. 7, 2023

(54) CARGO SHELF AND MODULAR CARGO SHELF SYSTEM

(71) Applicant: Indiev, Inc, Los Angeles, CA (US)

(72) Inventors: Andre Hudson, Los Angeles, CA (US); Young Joon Ju, Los Angeles, CA (US)

(21) Appl. No.: 17/805,521

(22) Filed: Jun. 6, 2022

(51) Int. Cl. B60R 5/00; B60R 5/04

(52) U.S. Cl. CPC B60R 5/003; B60R 5/045

(57) ABSTRACT

Cargo shelves and modular cargo shelf systems for passenger vehicles are provided. A cargo shelf can include three horizontal sections, two of which can be connected by a vertical section, and two of which can be connected by an angled section. The cargo shelf can have rails on a first side and a cushion on the opposite side. The cargo shelf can further include handles on opposite ends thereof. A modular cargo shelf system can include at least one cargo shelf and at least one click and lock module configured to be removably inserted into the rails of the at least one cargo shelf.

### BACKGROUND

Passenger vehicles are often used to store and transport cargo of the owner and/or passengers. Consumers are constantly on the lookout for increased cargo space and flexibility in the passenger vehicle marketplace. Such vehicles typically have a trunk or hatchback area near the rear of the vehicle behind the rear row of seats.

### BRIEF SUMMARY

Embodiments of the subject invention provide novel and advantageous cargo shelves and modular cargo shelf systems for passenger vehicles, as well as methods of using and fabricating the same. A cargo shelf can include three horizontal sections, two of which can be connected by a vertical section, and two of which can be connected by an angled section. The cargo shelf can have rails on a first side and a cushion on the opposite side. The cargo shelf can further include handles on opposite ends thereof. A modular cargo shelf system can include at least one cargo shelf and at least one click and lock module (as described in more detail below) configured to be removably inserted into the rails of the at least one cargo shelf.

In an embodiment, a cargo shelf for a passenger vehicle can comprise: a first horizontal section; a second horizontal section; a third horizontal section; a vertical section that is perpendicular or approximately perpendicular to (e.g., at an angle of 85° to 95° with respect to) the first horizontal section, the second horizontal section, and the third horizontal section, wherein the vertical section connects the first horizontal section and the second horizontal section; and an angled section that is disposed at a first angle in a range of from 20° to 70° with respect to the first horizontal section, the second horizontal section, and the third horizontal section, wherein the angled section is disposed at a second angle in a range of from 20° to 70° with respect to the vertical section, and wherein the angled section connects the second horizontal section and the third horizontal section. The cargo shelf can comprise a first side and a second side opposite to the first side, wherein the first horizontal section comprises a first surface on the first side and a second surface opposite from the first surface and on the second side, wherein the vertical section comprises a first surface on the first side and a second surface opposite from the first surface and on the second side, wherein the second horizontal section comprises a first surface on the first side and a second surface opposite from the first surface and on the second side, wherein the angled section comprises a first surface on the first side and a second surface opposite from the first surface and on the second side, and wherein the third horizontal section comprises a first surface on the first side and a second surface opposite from the first surface and on the second side.

The first side can comprise at least one rail. The first side can further comprise at least one hole, the at least one rail being respectively disposed in the at least one hole. The first surface of the first horizontal section can comprise at least one rail (e.g., exactly one rail), the first surface of the vertical section can comprise at least one rail (e.g., exactly one rail), the first surface of the second horizontal section can comprise at least one rail (e.g., exactly one rail), the first surface of the angled section can comprise at least one rail (e.g., exactly one rail), and/or the first surface of the third horizontal section can comprise at least one rail (e.g., exactly one rail). The second side can comprise a cushion, and the second surface of the second horizontal section and the second surface of the angled section can comprise the cushion. Each rail of the at least one rail can be configured to have a click and lock module (as described in more detail herein) removably inserted thereinto. The first surface of the first horizontal section, the first surface of the vertical section, the first surface of the second horizontal section, the first surface of the angled section, and the first surface of the third horizontal section can be monolithically formed with each other. The second surface of the first horizontal section, the second surface of the vertical section, the second surface of the second horizontal section, the second surface of the angled section, and the second surface of the third horizontal section can be monolithically formed with each other. The first side of the cargo shelf can comprise, for example, a rubber material and/or a plastic material. The cargo shelf can further comprise a first handle at a first end of the cargo shelf and a second handle at a second end of the cargo shelf opposite from the first end. The first handle can comprise a hole through the first horizontal surface, a first depressed section on a first surface of the first horizontal surface, and a second depressed section on a second surface of the first horizontal surface opposite from the first surface. The second handle can comprise a hole through the third horizontal surface, a first depressed section on a first surface of the third horizontal surface, and a second depressed section on a second surface of the third horizontal surface opposite from the first surface. The first horizontal surface can be disposed in a same plane as the third horizontal surface. The first angle can be in a range of, for example, from 30° to 60° (e.g., 45° or about 45°), and the second angle can be in a range of from 30° to 60° (e.g., 45° or about 45°).

In another embodiment, a modular cargo shelf system can comprise: at least two cargo shelves as described herein; at least one click and lock module (as described herein); and a cargo mat (as described in more detail herein) comprising at least one rail configured to receive the at least one click and lock module.

In another embodiment, a passenger vehicle can comprise a cargo shelf as described herein and/or a modular cargo shelf system as described herein present in a rear storage section of the passenger vehicle. The passenger vehicle can be, for example, an electric vehicle.

### BRIEF DESCRIPTION OF DRAWINGS

FIGS. 1A-1E show a cargo shelf, according to an embodiment of the subject invention. FIG. 1A shows a top view; FIG. 1B shows a front view; FIG. 1C shows a side view; FIG. 1D shows a rear view; and FIG. 1E shows a bottom view. The dotted lines between these figures indicate the same portions shown in the different figures.

FIG. 2 shows a top perspective view of a cargo shelf, according to an embodiment of the subject invention.

FIG. 3 shows a top perspective view of a cargo shelf, according to an embodiment of the subject invention.

FIG. 4 shows a side view of a cargo shelf, according to an embodiment of the subject invention.

FIG. 5 shows a bottom perspective view of a cargo shelf, according to an embodiment of the subject invention.

FIG. 6 shows a bottom perspective view of a cargo shelf, according to an embodiment of the subject invention.

FIG. 7 shows a rear section of a passenger vehicle.

FIGS. 8A-8D shows a cargo shelf being disposed in a rear section of a passenger vehicle. FIG. 8A shows the cargo shelf elevated above the supports; FIG. 8B shows the cargo shelf in place; FIG. 8C shows a close-up view of a portion of the cargo shelf elevated above the supports; and FIG. 8D shows a close-up view of a portion of the cargo shelf in place.

FIGS. 9A-9D show different configurations of one or two cargo shelves in place in a rear section of a passenger vehicle.

FIG. 10 shows an image of a user in a real-world setting making use of two cargo shelves and a passenger vehicle. In this example, the user is at a beach and the cargo shelves are in place in a rear section of the passenger vehicle and being used for a pet.

FIG. 11 shows an image of a user in a real-world setting making use of two cargo shelves and a passenger vehicle. In this example, the user is at a campsite and the cargo shelves are being used for seating, in one case with areas to set objects and in another case as an elevated seat.

FIG. 12 shows an image of a user in a real-world setting making use of two cargo shelves and a passenger vehicle. In this example, the user is at a canyon and one cargo shelf remains in a rear section of the passenger vehicle for cargo storage while another cargo shelf is being used to dispose a drone case thereon.

FIG. 13 shows a plan view of part of a modular cargo storage system that can be used together with one or more cargo shelves, according to an embodiment of the subject invention. The inset is an enlarged view of the left-most rail depicted in the main portion of the figure.

FIG. 14A shows a plan view of part of a modular cargo storage system that can be used together with one or more cargo shelves, according to an embodiment of the subject invention.

FIG. 14B shows a top view of two rails and two click and lock modules (“CL modules”) of a modular cargo storage system that can be used together with one or more cargo shelves, according to an embodiment of the subject invention.

FIG. 15A shows a plan view of part of a modular cargo storage system that can be used together with one or more cargo shelves, according to an embodiment of the subject invention.

FIG. 15B shows a top view of two rails and two CL modules of a modular cargo storage system that can be used together with one or more cargo shelves, according to an embodiment of the subject invention.

FIG. 16A shows a cross-sectional view of a CL module and a rail (in the top portion of the figure), and a top view of the CL module (in the bottom portion of the figure, linked by the dotted lines), that can be used together with one or more cargo shelves, according to an embodiment of the subject invention.

FIG. 16B shows a cross-sectional view of a CL module being inserted into a rail (in the top portion of the figure), and a top view of the CL module (in the bottom portion of the figure, linked by the dotted lines), that can be used together with one or more cargo shelves, according to an embodiment of the subject invention.

FIG. 16C shows a cross-sectional view of a CL module inserted into a rail (in the top portion of the figure), and a top view of the CL module (in the bottom portion of the figure, linked by the dotted lines), that can be used together with one or more cargo shelves, according to an embodiment of the subject invention.

FIG. 16D shows a cross-sectional view of a CL module inserted into a rail and having its handle rotated (in the top portion of the figure), and a top view of the CL module (in the bottom portion of the figure, linked by the dotted lines), that can be used together with one or more cargo shelves, according to an embodiment of the subject invention.

FIG. 17 shows a plan view of part of a modular cargo storage system that can be used together with one or more cargo shelves, according to an embodiment of the subject invention.

FIG. 18 shows a top view of two rails and two CL modules (with a band connected thereto) of a modular cargo storage system that can be used together with one or more cargo shelves, according to an embodiment of the subject invention.

FIG. 19 shows a plan view of part of a modular cargo storage system, which can be used together with one or more cargo shelves, containing some cargo items (depicted in dotted lines).

FIG. 20A shows a modular cargo storage system, which can be used together with one or more cargo shelves, in a passenger vehicle.

FIG. 20B shows a modular cargo storage system, which can be used together with one or more cargo shelves, in a passenger vehicle.

### DETAILED DESCRIPTION

Embodiments of the subject invention provide novel and advantageous cargo shelves and modular cargo shelf systems for passenger vehicles, as well as methods of using and fabricating the same. A cargo shelf can include three horizontal sections, two of which can be connected by a vertical section, and two of which can be connected by an angled section. The cargo shelf can have rails on a first side and a cushion on the opposite side. The cargo shelf can further include handles for ease of picking up, maneuvering, and/or carrying by a user (e.g., a passenger or driver of the passenger vehicle). A modular cargo system can include at least one cargo shelf and at least one click and lock module (as described in more detail below) configured to be removably inserted into the rails of the at least one cargo shelf. The modular cargo shelf system, which can further include a cargo mat with rails into which the at least one click and lock module can be removably inserted, can be used in the rear storage area of a passenger vehicle (e.g., an electric vehicle).

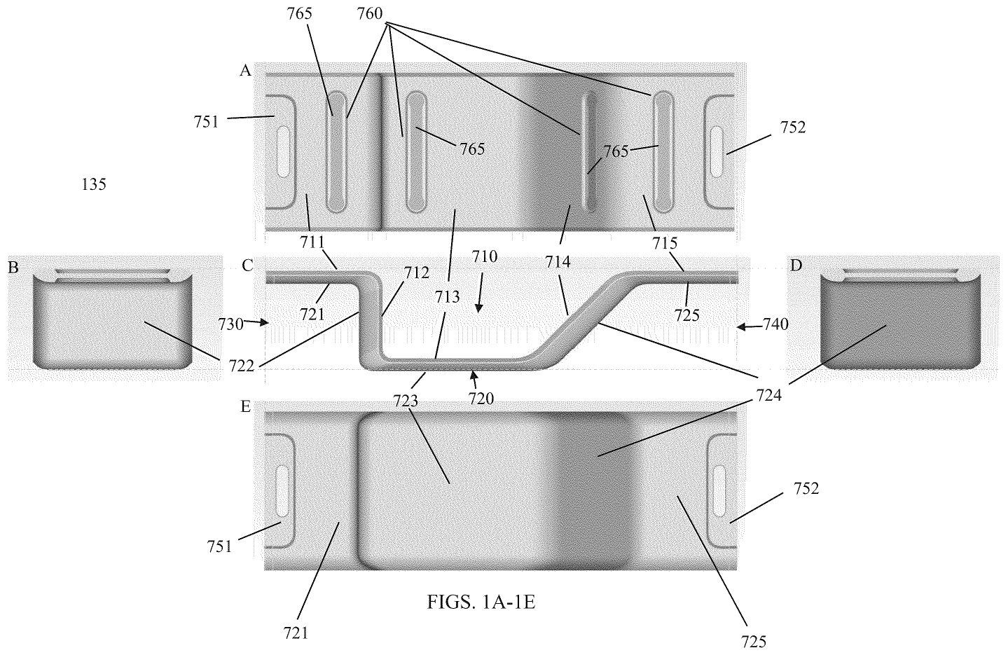

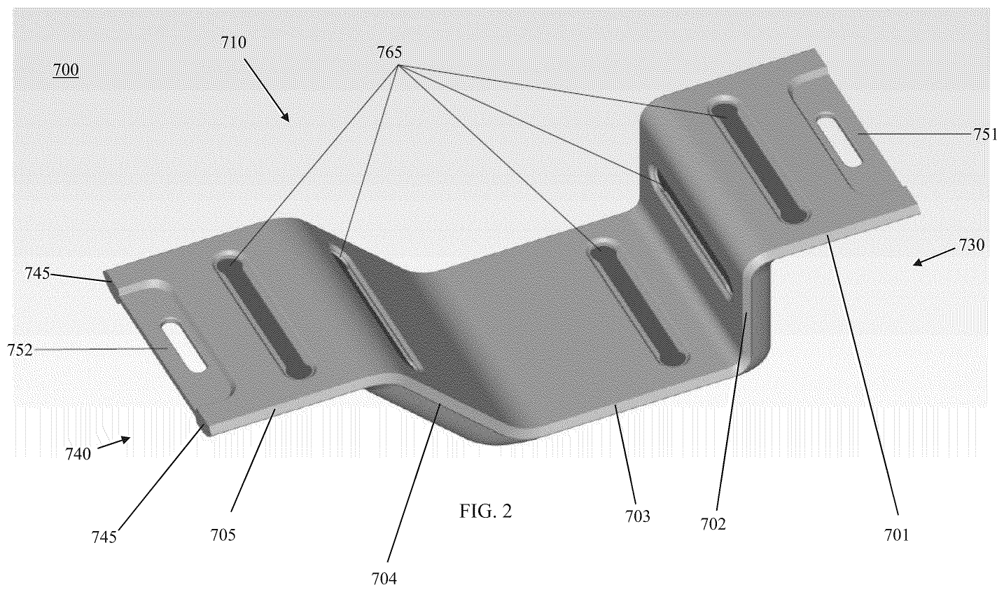

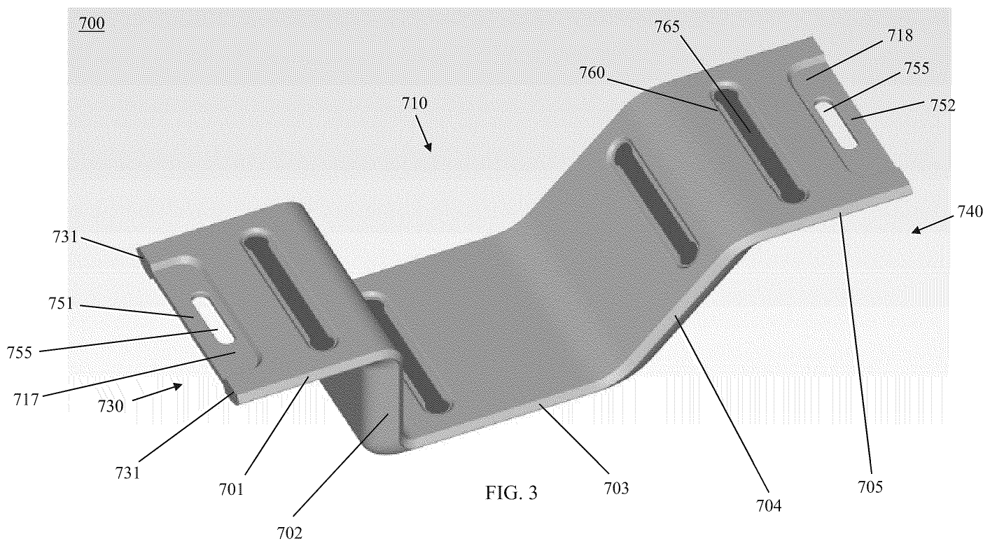

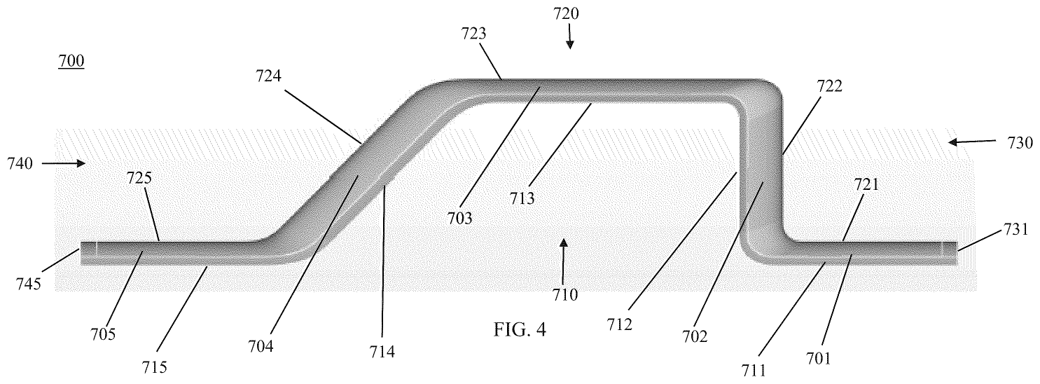

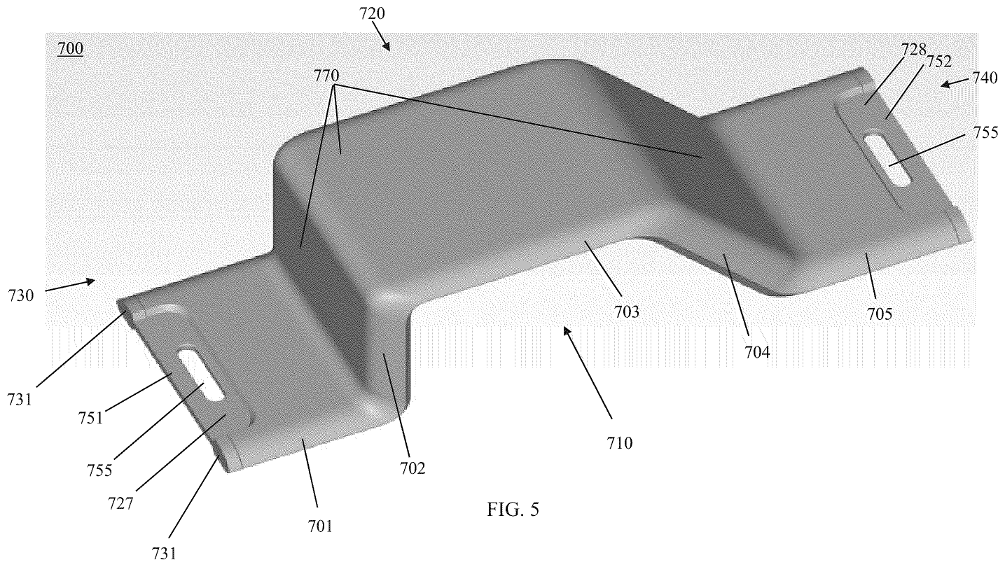

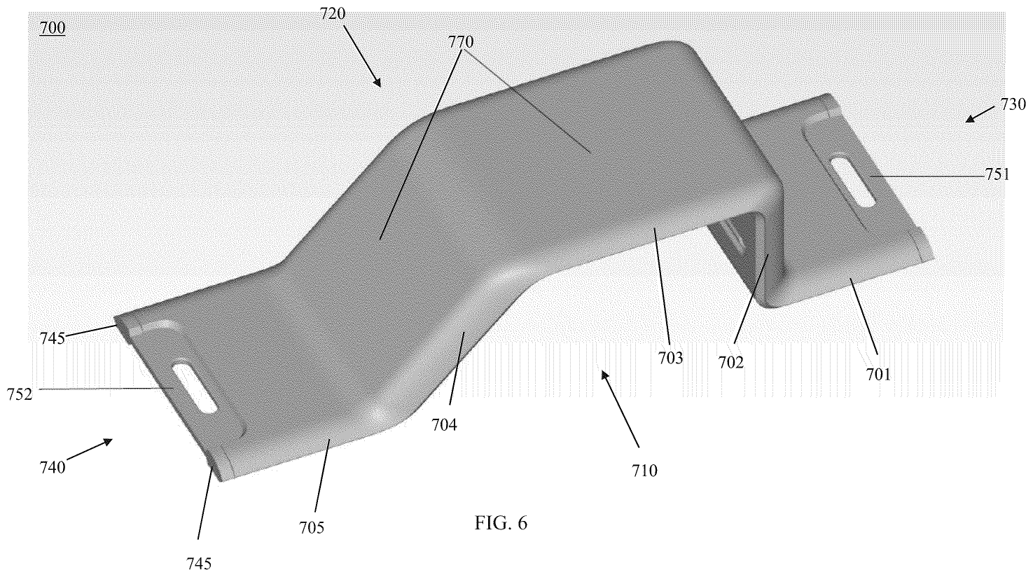

FIGS. 1A-1E show a top view, front view, side view, rear view, and bottom view, respectively, of a cargo shelf, according to an embodiment of the subject invention. FIGS. 2 and 3 show top perspective views of the cargo shelf, FIG. 4 shows a side view of the cargo shelf, and FIGS. 5 and 6 show bottom perspective view of the cargo shelf. Referring to FIGS. 1A-6, the cargo shelf 700 can comprise two functional sides-a first side 710 and a second side 720, along with a first end 730 and a second end 740. The cargo shelf can include a first horizontal section 701, a second horizontal section 703, a vertical section 702 connecting the first horizontal section 701 and the second horizontal section 703, a third horizontal section 705, and an angled section 704 connecting the second horizontal section 703 and the third horizontal section 705. Each horizontal section 701, 703, 705 can be perpendicular or approximately perpendicular (e.g., at an angle in a range of from 85° to 95° with respect to each other) to the vertical section 702. The angled section 704 can be disposed at an angle (e.g., in a range of from 20° to 70°, or in a range of from 30° to 60°, such as 45° or about 45°) with respect to each horizontal section 701, 703, 705 and at an angle (e.g., in a range of from 20° to 70°, or in a range of from 30° to 60°, such as 45° or about 45°) with respect to the vertical section 702.

The first horizontal section 701 can have a first surface 711 on the first side 710 and a second surface 721 opposite from the first surface 711 and on the second side 720. The vertical section 702 can have a first surface 712 on the first side 710 and a second surface 722 opposite from the first surface 712 and on the second side 720. The second horizontal section 703 can have a first surface 713 on the first side 710 and a second surface 723 opposite from the first surface 713 and on the second side 720. The angled section 704 can have a first surface 714 on the first side 710 and a second surface 724 opposite from the first surface 714 and on the second side 720. The third horizontal section 705 can have a first surface 715 on the first side 710 and a second surface 725 opposite from the first surface 715 and on the second side 720. The cargo shelf 700 can include a first end surface 731 at the first end 730 and a second end surface 745 at the second end 740. The first end surface 731 can be an end of the first horizontal section 701, and the second end surface 745 can be an end of the third horizontal section 705.

The first horizontal section 701 and the third horizontal section 705 can be disposed in the same plane, such that the first surfaces thereof 711,715 are disposed in the same plane as each other and/or the second surfaces thereof 721,725 are disposed in the same plane as each other. The second horizontal section 703 can be disposed in a different plane form both the first horizontal section 701 and the third horizontal section 705, such that the first surface 713 of the second horizontal section 703 is disposed in a different plane from both first surfaces 711,715 of the first horizontal section 701 and the third horizontal section 705 and/or the second surface 723 of the second horizontal section 703 is disposed in a different plane from both second surfaces 721,725 of the first horizontal section 701 and the third horizontal section 705.

The first side 710 of the cargo shelf 700 can include rails 765 that can be used for modular storage, such as using click and lock modules (“CL modules”) 300, which will be described in detail later. The rails 765 can be included within holes (or indentations or grooves) 760 of the first side 710. In some embodiments, the rails 765 can be separate from the material of the first side 710, and in some embodiments, the rails 765 can be made from the holes 760 within the material of the first side 710. The first side 710 can be, for example, a cargo mat surface or a cargo-mat-like surface (e.g., rubber or plastic), though embodiments are not limited thereto. The holes 760 can be similar to the holes 210 described in detail later and can have any or all of the features thereof. The rails 765 can be similar to the rails 110 described in detail later and can have any or all of the features thereof.

Any or all of the first horizontal section 701, the vertical section 702, the second horizontal section 703, the angled section 704, and the third horizontal section 705 can include a hole 760 and/or a rail 765. For example, in one embodiment, each of the first horizontal section 701, the vertical section 702, the second horizontal section 703, the angled section 704, and the third horizontal section 705 includes exactly one rail 765, which may be within a hole 760 or may be made by the hole 760 itself.

The second side 720 can include a cushion 770, which can include a soft and/or deformable material that is comfortable for a human user to sit on. The cushion 770 can cover one or more of the first horizontal section 701, the vertical section 702, the second horizontal section 703, the angled section 704, and the third horizontal section 705.

Any or all of the first surface 711 of the first horizontal section 701, the first surface 712 of the vertical section 702, the first surface 713 of the second horizontal section 703, the first surface 714 of the angled section 704, and the first surface 715 of the third horizontal section 705 can be monolithically formed with each other. Any or all of the second surface 721 of the first horizontal section 701, the second surface 722 of the vertical section 702, the second surface 723 of the second horizontal section 703, the second surface 724 of the angled section 704, and the second surface 725 of the third horizontal section 705 can be monolithically formed with each other. In some embodiments (e.g., if the cushion 770 is not present), any or all of the first surface 711 of the first horizontal section 701, the first surface 712 of the vertical section 702, the first surface 713 of the second horizontal section 703, the first surface 714 of the angled section 704, the first surface 715 of the third horizontal section 705, the second surface 721 of the first horizontal section 701, the second surface 722 of the vertical section 702, the second surface 723 of the second horizontal section 703, the second surface 724 of the angled section 704, and the second surface 725 of the third horizontal section 705 can be monolithically formed with each other.

The cargo shelf 700 can include a first handle 751 at the first end 730 and/or a second handle 752 at the second end 740. The first handle 751 can include a handle hole 755 configured for a user's hand to fit through, a depressed section 717 on the first side 710, and/or a depressed section 727 on the second side 720. The second handle 752 can include a handle hole 755 configured for a user's hand to fit through, a depressed section 718 on the first side 710, and/or a depressed section 728 on the second side 720.

At any or all transitions between the first horizontal section 701, the vertical section 702, the second horizontal section 703, the angled section 704, and the third horizontal section 705, the first side 710 and/or the second side 720 can be curved or slightly curved (as seen in, e.g., FIGS. 1C and 2-6), though embodiments are not limited thereto. That is, the first side 710 can have a curve between the first surface 711 of the first horizontal section 701 and the first surface 712 of the vertical section 702; and the same can be true for any or all of the other transitions between sections on either or both of the first side 710 and the second side 720.

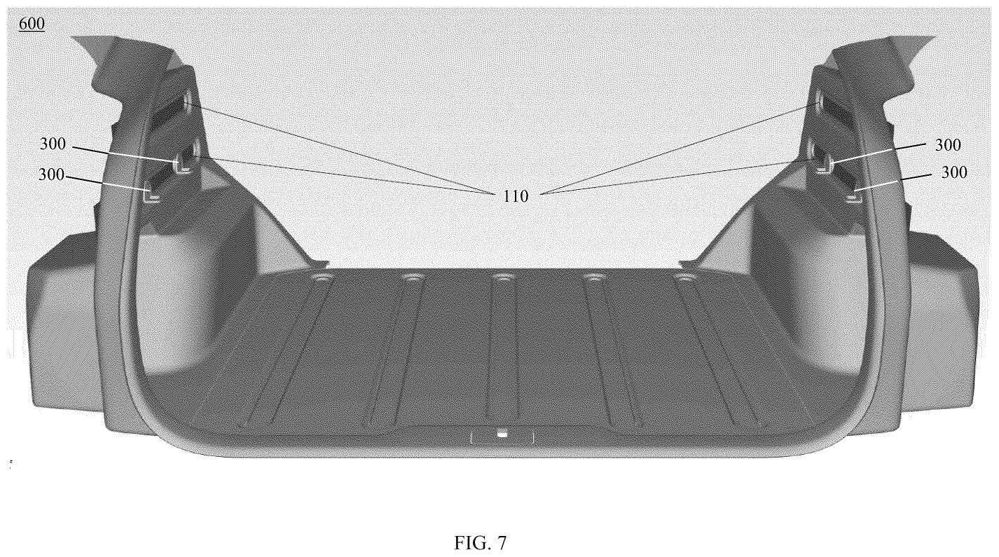

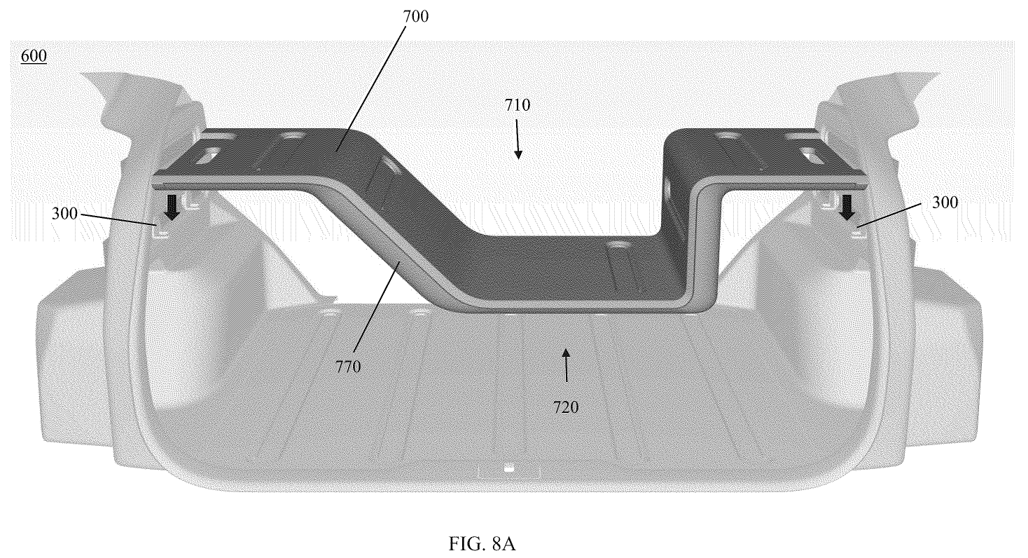

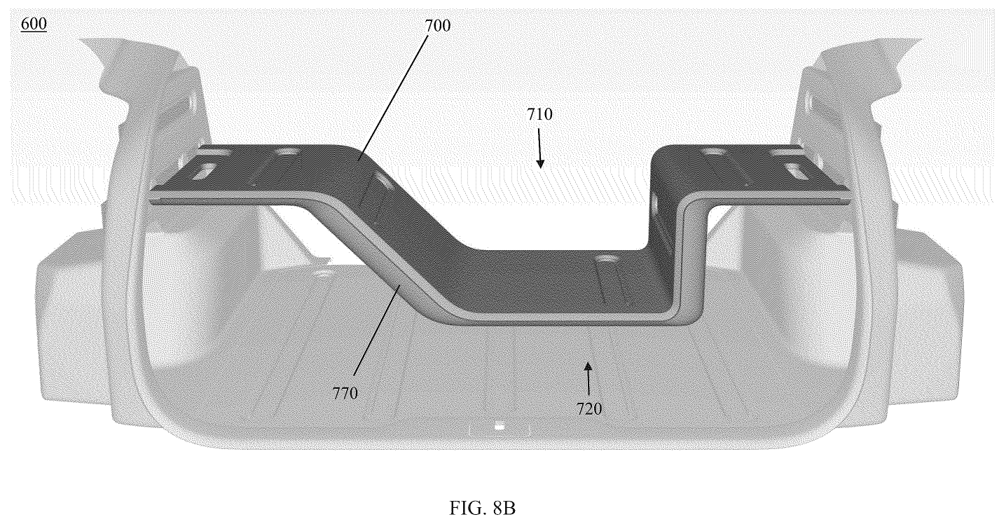

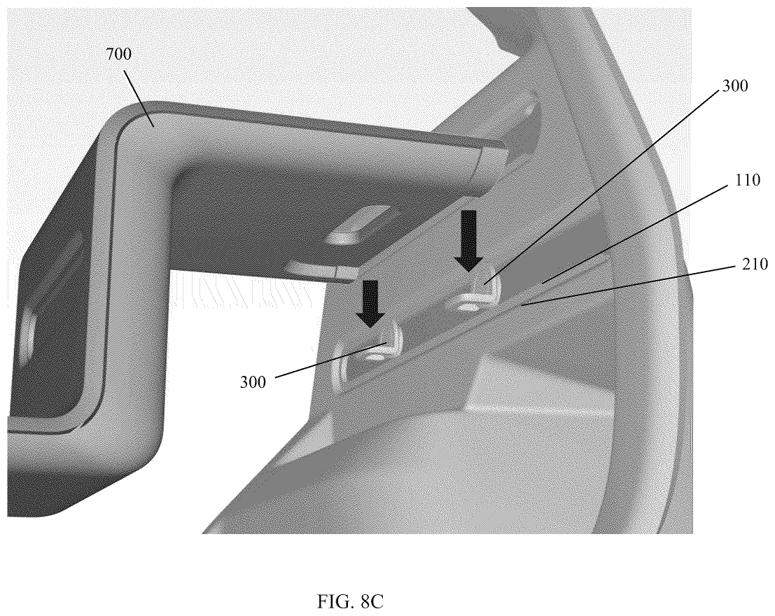

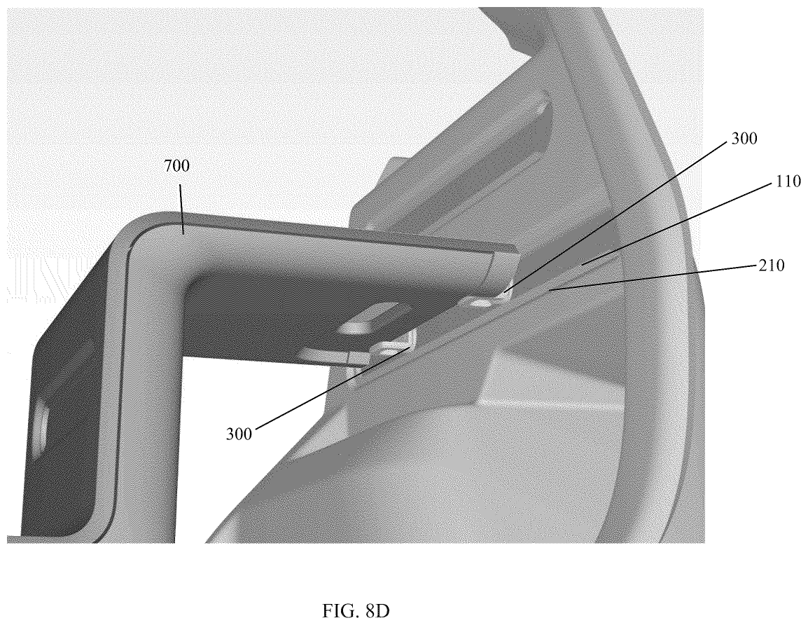

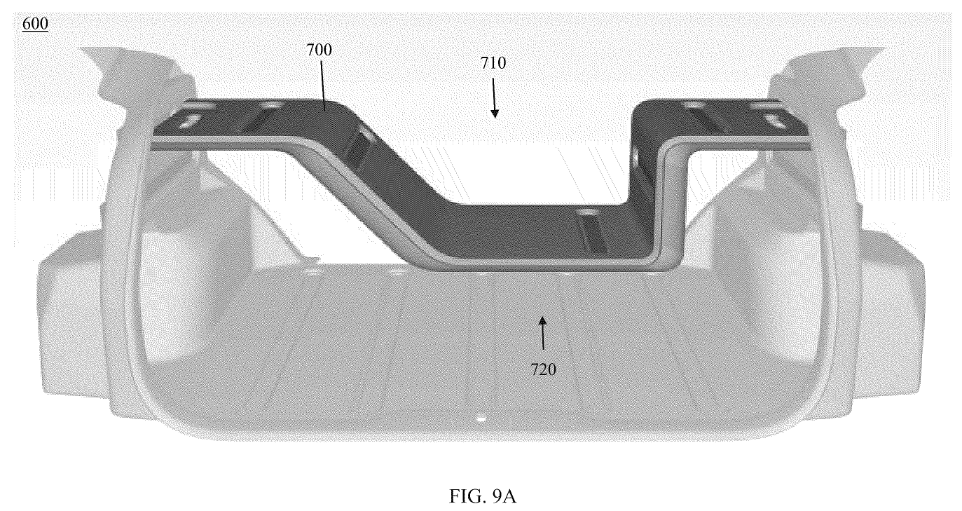

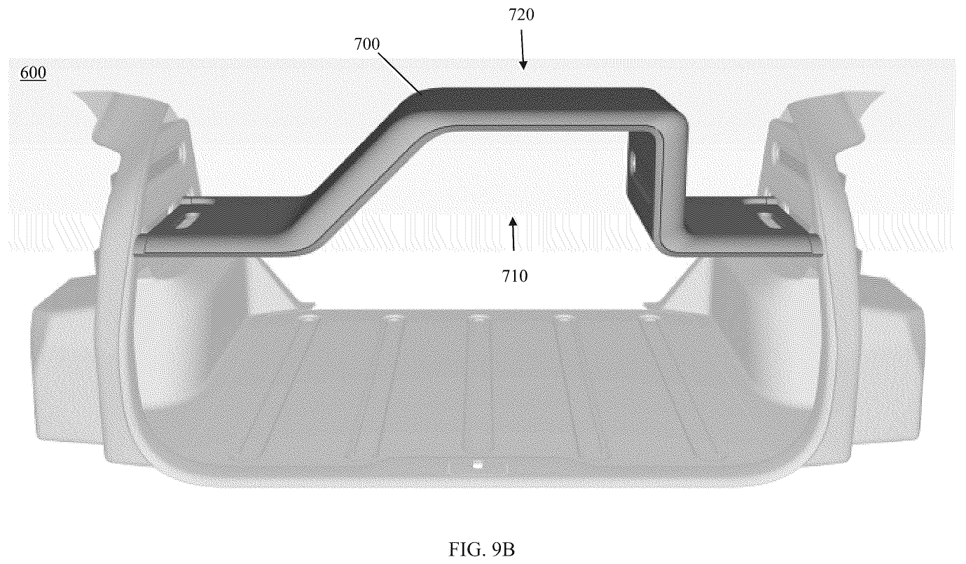

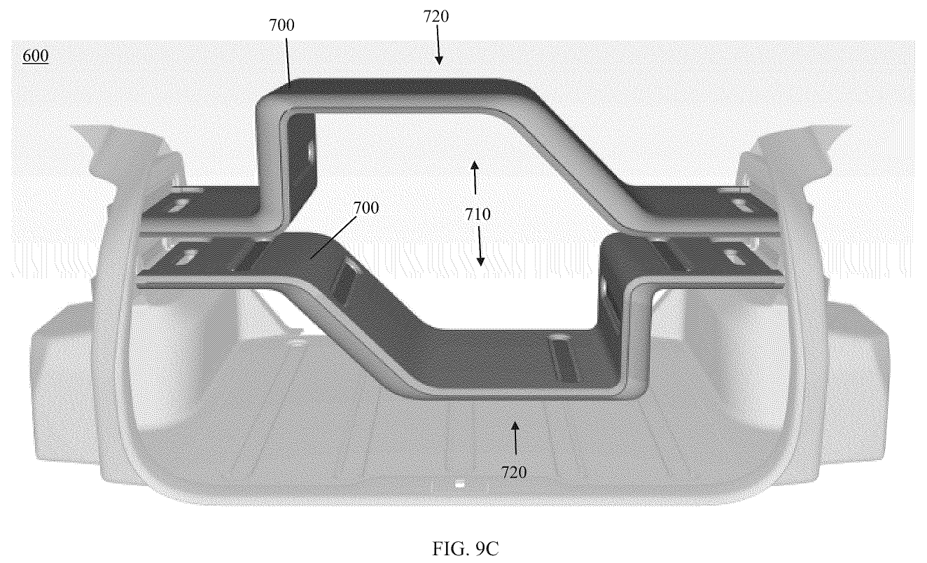

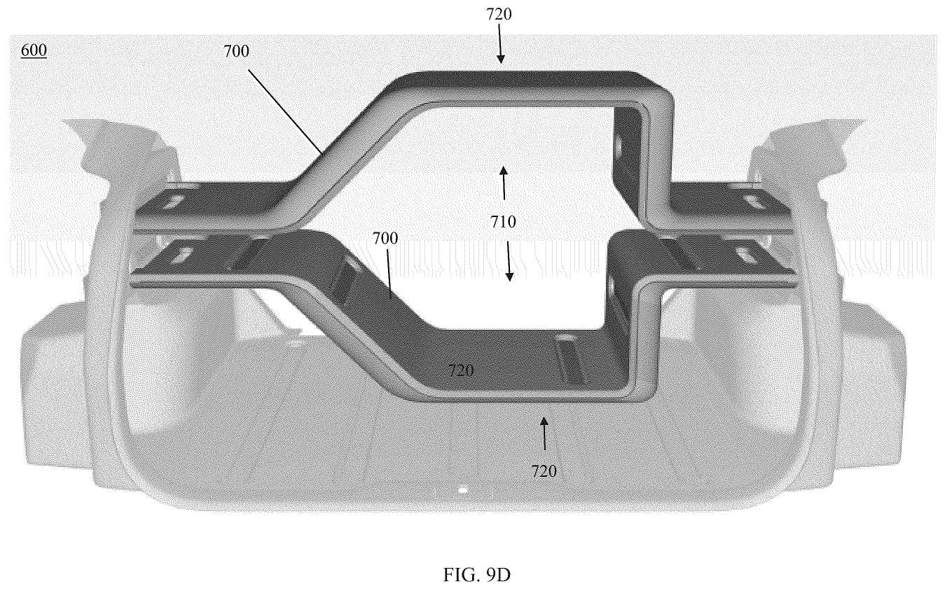

Referring to FIGS. 7-9D, one or more of the cargo shelves 700 as described herein can be removably disposed in a rear section of a passenger vehicle 600. For example, a rear section of a passenger vehicle 600 can include a plurality of rails 110 (described in more detail below) and a plurality of CL modules 300 (described in more detail below). Referring again to FIGS. 8A-8D, a cargo shelf 700 can be disposed on supports, which can be, for example, CL modules 300. The depressed section 717,727,718,728 can be disposed on the supports (e.g., CL modules 300) such that the relatively elevated surface 711,721,715,725 adjacent to the depressed section 717,727,718,728 can help hold the cargo shelf 700 and inhibit or prevent it from sliding (e.g., during operation of the passenger vehicle 600). Alternatively, the surface 711,721,715,725 can be disposed directly on the supports (e.g., CL modules 300) whether the depressed section(s) 717,727,718,728 is/are present or not; though, this would increase the chances of the cargo shelf 700 sliding. Referring again to FIGS. 9A-9D, one or more cargo shelves 700 can be disposed in the rear section of a passenger vehicle 600 in many different configurations, depending on the desired cargo to be transported and/or on the needs or preferences of the user (e.g., a driver or passenger of the passenger vehicle). The cargo shelf 700 can have a width that is about the same as (e.g., at least 97% of, but not more than 100% of) an interior width of the rear section of the passenger vehicle 600 such that it can fit therewithin without sliding side to side.

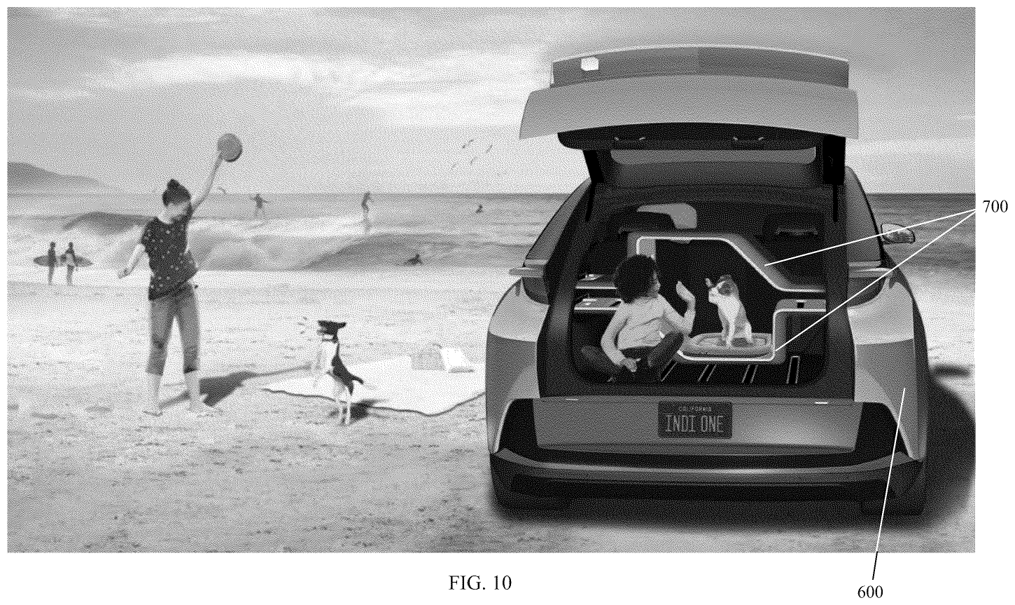

FIGS. 10-12 show examples of real-world uses of cargo shelves 700 disposed in a rear section of a passenger vehicle 600 and/or outside the passenger vehicle 600. FIG. 10 shows an example where two users have two cargo shelves 700 disposed in the rear section of the passenger vehicle 600 to form a cargo area for a pet (and related supplies) on a trip to the beach. A user (e.g., the child as depicted in FIG. 10) can sit in the passenger vehicle 600 and attend to and/or play with the pet while it is on a cargo shelf 700.

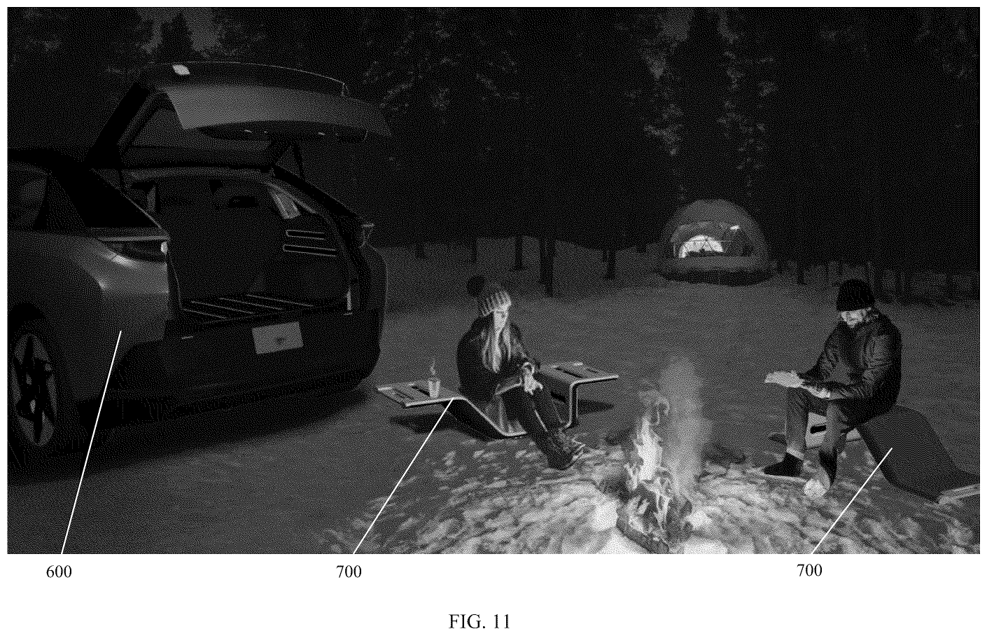

FIG. 11 shows an example where two users at a campsite are each sitting on a cargo shelf 700 at a camp site, and the passenger vehicle 600 is there for storing the cargo shelves 700 when not in use. A first user (near the center of FIG. 11) is using the cargo shelf 700 with the first side 710 facing up, where the second horizontal section 703 functions as the seat and the first horizontal section 701 and the third horizontal section 705 function as surfaces to place objects (e.g., function of end tables). A second user (on the right side of FIG. 11) is using the cargo shelf 700 with the second side 720 facing up, where the second horizontal section 703 functions as the seat and is elevated off the ground. This second user also benefits from the cushion 770 on the second side 720 of the cargo shelf 700.

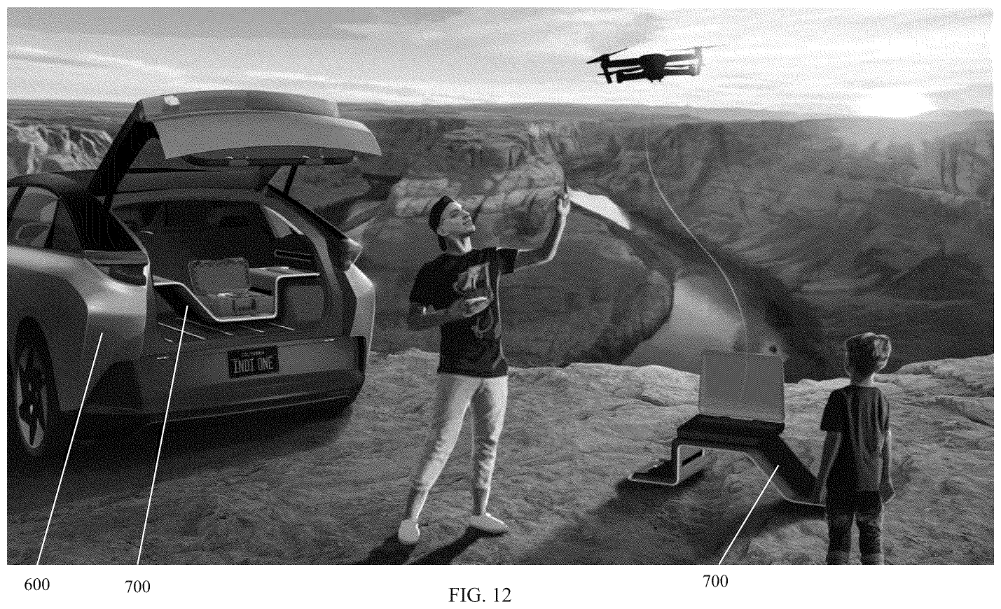

FIG. 12 shows an example where two users at a canyon have a first cargo shelf 700 in the rear section of the passenger vehicle 600 storing cargo and a second cargo shelf 700 outside the vehicle and functioning as a table on which to set an object (e.g., the case for the drone being flown). The second cargo shelf 700 can easily be placed back in the rear section of the passenger vehicle 600 when not in use.

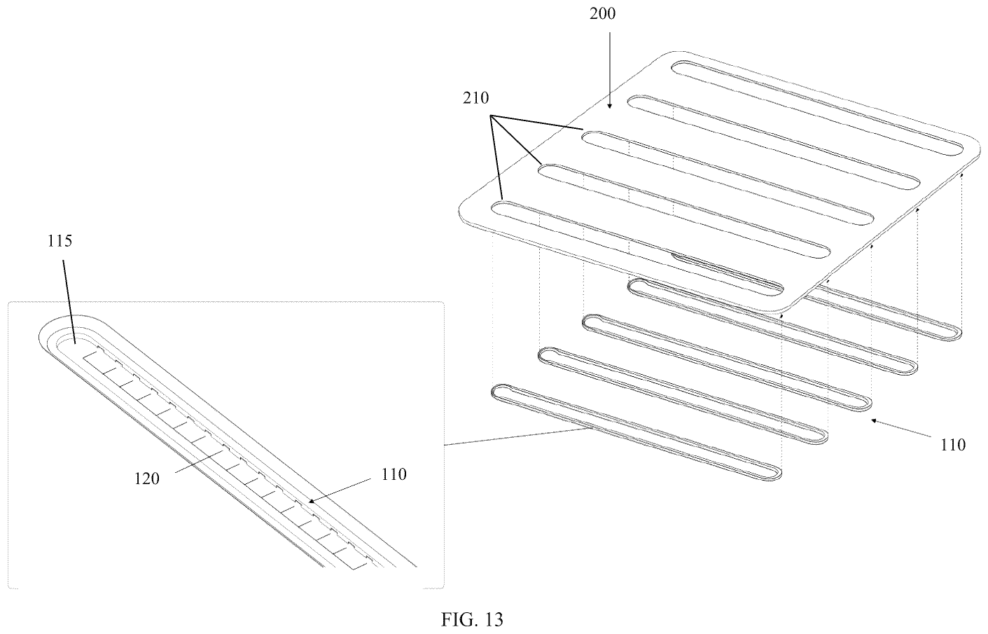

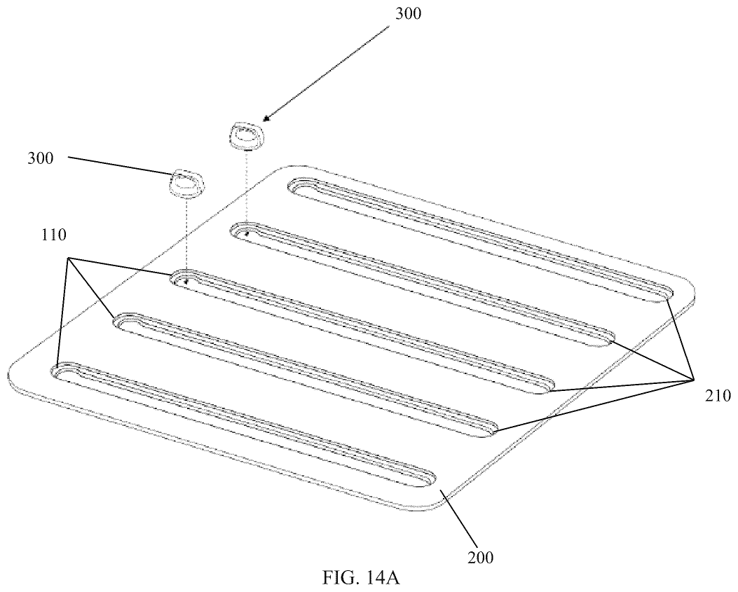

The cargo shelves of embodiments of the subject invention can be utilized together with the modular cargo storage system for passenger vehicle described in U.S. patent application Ser. No. 17/409,089, which is hereby incorporated by reference herein in its entirety. FIGS. 13-20B correspond to FIGS. 1-8B of U.S. patent application Ser. No. 17/409,089. The modular cargo storage system described in U.S. patent application Ser. No. 17/409,089 will now be described herein in further detail.

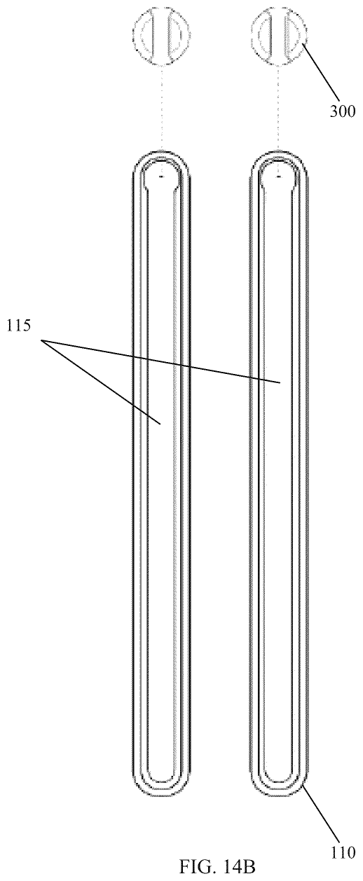

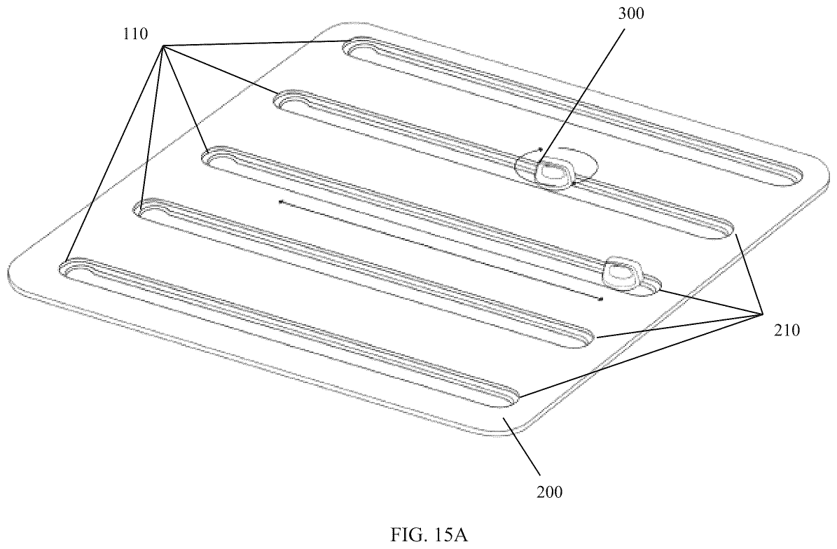

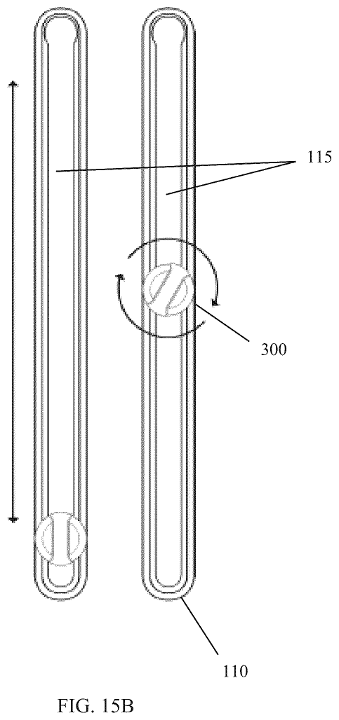

FIGS. 13 and 14A show plan views of part of a modular cargo storage system. The modular cargo storage system can include a cargo load mat 200 that can include a plurality of holes 210. The system can further include a plurality of rails 110 each having a plurality of slots 120 at a lower portion thereof. The rails 110 can be exposed through the holes 210 of the cargo load mat 200 (see, e.g., FIG. 14A) and can either be disposed respectively within the holes 210 of the cargo load mat 200 or disposed below the cargo load mat 200 while being exposed respectively through the holes 210. A plurality of CL modules 300 can be provided and are configured to be removably inserted into the rails 110 of the system. FIG. 14B shows an enlarged top view of the two rails 110 of FIG. 14A that have the CL modules 300 shown with dotted lines.

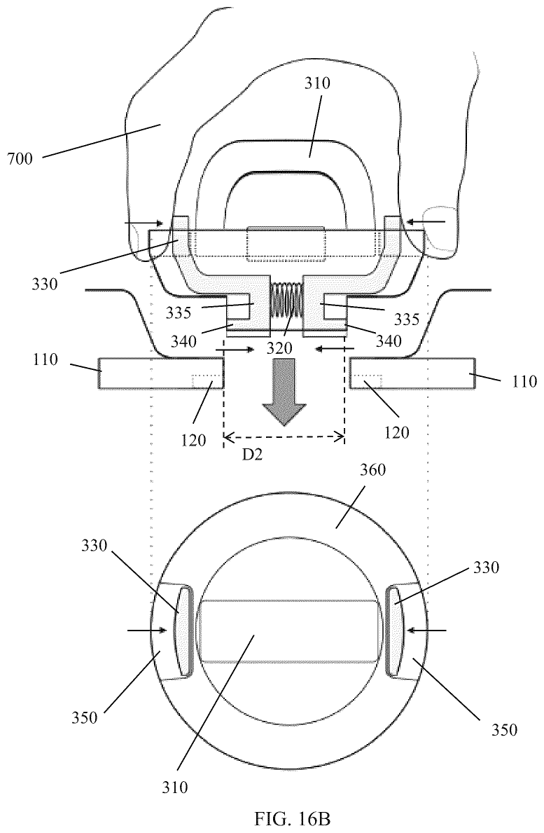

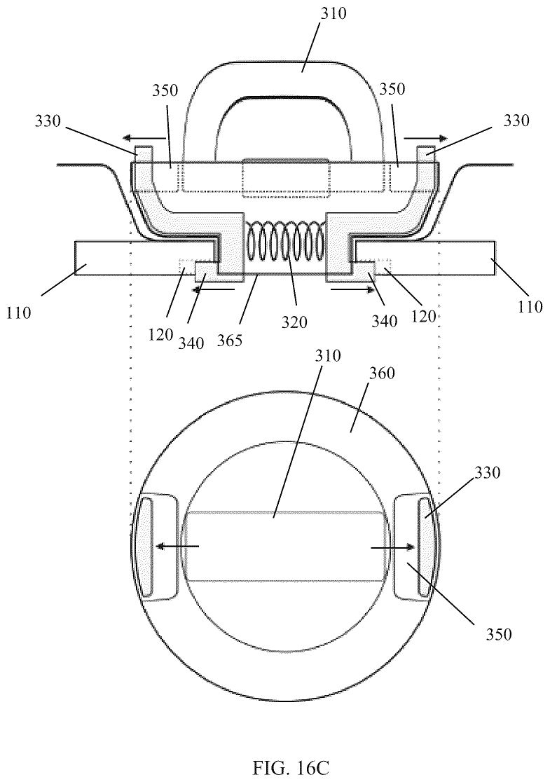

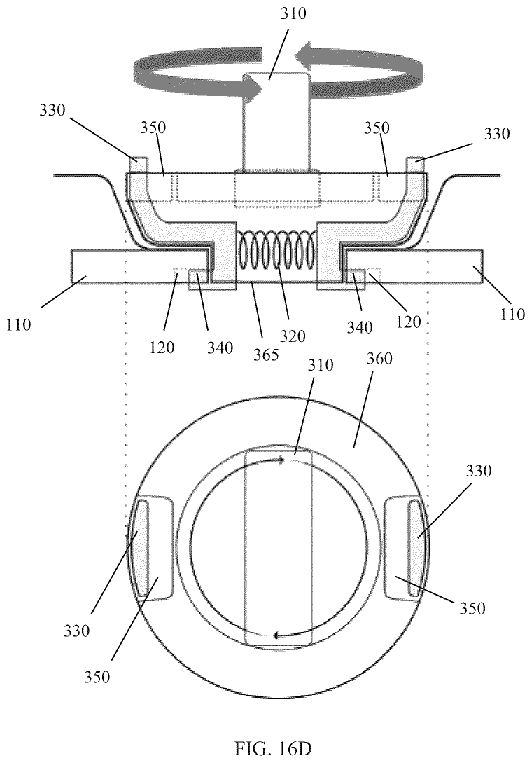

The inset of FIG. 13 shows an enlarged view of one of the rails 110 from the main portion of the figure. As seen in the inset of FIG. 13, slots 120 can be provided along the longitudinal length of the rail 110 (though embodiments are not limited thereto). The slots 120 can be provided on both sides of the opening 115 of the rail, such that they match up with each other. That is, two slots 120 can be provided on opposite sides of the opening 115 in the same position along the length of the rail 110 to make a slot position into which the lower lateral extending portions 340 of a CL module 300 can be inserted to keep the CL module in place within the rail 110 (see also FIGS. 16A-16D). In some embodiments, each slot 120 of a rail 110 can have a corresponding slot 120 provided on the opposite side of the opening 115 in the same position along the length of the rail 110 to make a slot position into which the lower lateral extending portions 340 of a CL module 300 can be inserted to keep the CL module in place within the rail 110. Any or all rails 110 can have slots 120 as described herein.

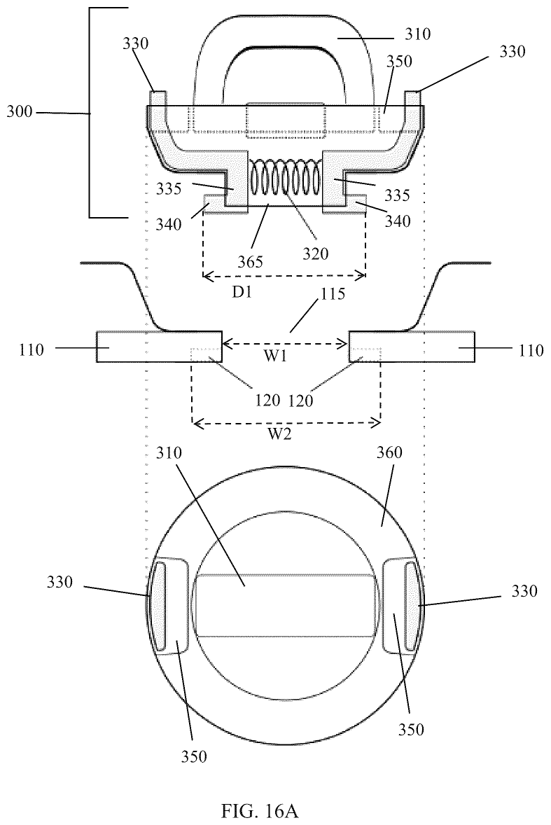

Referring to FIG. 15A, the CL modules 300 can be rotated (e.g., to enable a band 400 to be more conveniently attached to the handle 310 of the CL module 300, or in some cases to enable the CL module 300 to move within the rail 110). The CL module 300 can be slid within the same rail 110 by squeezing the upper flanges 330 (such that the lower lateral extending portions 340 are no longer in the slots 120) and then sliding the CL module 300. When the CL module 300 is in the desired position within the rail 110, the upper flanges 330 can be released such that the lower lateral extending portions 340 are inserted into the slots 120 in the new location. FIG. 15B shows an enlarged top view of the two rails 110 of FIG. 15A that have the CL modules 300 inserted therewithin. The long double arrow in FIGS. 15A and 15B represents how the CL module 300 can be disposed along the entire length of the opening 115 of the rail 110, and the circular arrows in FIGS. 15A and 15B represents how the handle 310 of the CL module 300 can be rotated to any desired position.

FIGS. 16A-16D show cross-sectional views of a CL module 300 and a rail 110 (in the top portion of each figure), and top views of the CL module 300 (in the bottom portion of each figure, linked by the dotted lines), demonstrating inserting a CL module 300 into a slot 200 of a rail 110. Referring to FIGS. 16A-16D, the CL module 300 can include a handle 310 at a top portion thereof, which can be used for, e.g., gripping/holding the CL module 300 by a user 700 and/or connecting a band 400. The CL module 300 can have upper flanges 330 that are connected to lower inner walls 335, which are adjacent to a spring 320. The lower inner walls 335 are connected to lower lateral extending portions 340 that extend laterally away from a lower portion of the CL module 300. The CL module 300 can include two upper flanges 330 opposite (e.g., diametrically opposite) from each other, two lower inner walls 335 opposite (e.g., diametrically opposite) from each other and on respective opposite ends of the spring 320, and two lower lateral extending portions 340 opposite (e.g., diametrically opposite) from each other and near respective opposite ends of the spring 320. Each respective upper flange 330 can be monolithically formed with the respective lower inner wall 335 and/or the respective lower inner wall 335 can be monolithically formed with the respective lower lateral extending portion 340 (e.g., the upper flange 330, the lower inner wall 335, and the lower lateral extending portion 340 can all be monolithically formed with each other on each respective side of the CL module 300).

The CL module 300 can further comprise a main body 360, which can in many embodiments have a circular or generally circular shape (e.g., the upper surface of the main body 360 can be circular or generally circular, as shown in the bottom portions of FIGS. 16A-16D). The main body 360 can have indented spaces 350 at portions where the upper flanges 330 are disposed. In this way, the CL module 300 is (and the upper flanges 330 of the CL module 300 are) configured such that the upper flanges 330 can be pressed towards each other (and towards a radial center of the CL module 300) causing the lower inner walls 335 to compress the spring 320 and causing the lower lateral extending portions 340 to move inward towards each other (and towards a radial center of the CL module 300). The main body 360 can optionally include a lower surface 365 such that the spring 320 is enclosed from below by the lower surface 365 of the main body 360. A portion of the upper flange 330 connecting to the lower inner wall 335 can optionally be contained within the lateral wall of the main body 360, as can the lower inner wall 335 itself. The lower lateral extending portion 340 can optionally extend out from the lower wall 335 through a hole in the lateral wall of the main body 360.

The opening 115 of the rail 110 can have a width W1 (from one side that has slots 120 to the other side that has slots 120) that is less than a distance D1 (measured in a lateral (or radial) direction (i.e., the direction in which the spring 320 extends and compresses) of the CL module 300) from an outer lateral surface of a first lower lateral extending portion 340 to an outer lateral surface of a second lower lateral extending portion 340 (opposite from the first lower lateral extending portion 340) when the spring 320 is not compressed (i.e., when the upper flanges 330 are not squeezed at all, this distance D1 being a greatest distance between the outer surfaces of the lower lateral extending portions 340). The distance D2 (measured in the lateral (or radial) direction (i.e., the direction in which the spring 320 extends and compresses) of the CL module 300) from the outer lateral surface of the first lower lateral extending portion 340 to the outer lateral surface of the second lower lateral extending portion 340 when the spring 320 is fully compressed (i.e., when the upper flanges 330 are squeezed, this distance D2 being a smallest distance between the outer surfaces of the lower lateral extending portions 340) is less than the width W1 of the opening 115 of the rail 110. In this way, the CL module 300 stays in the slots 120 of the rail 110 once it is inserted thereinto unless the upper flanges 330 are squeezed to remove the CL module 300 from the slots 120.

A greatest width W2 between two slots 120 opposite to each other across the opening 115 of the rail 120 is greater than both W1 and D2. The width W2 can be greater than, equal to, or less than D1. If W2 is less than D1, then when the CL module 300 is disposed in the slots 120 and the upper flanges 330 are not squeezed at all, the spring 320 will still have some compression.

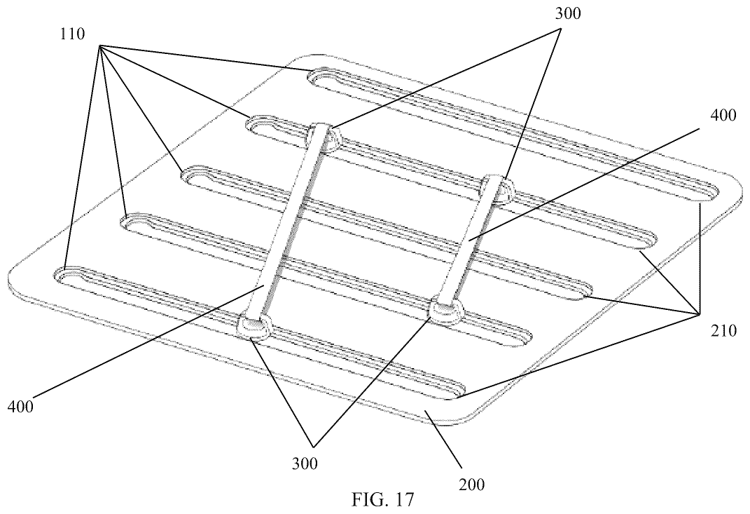

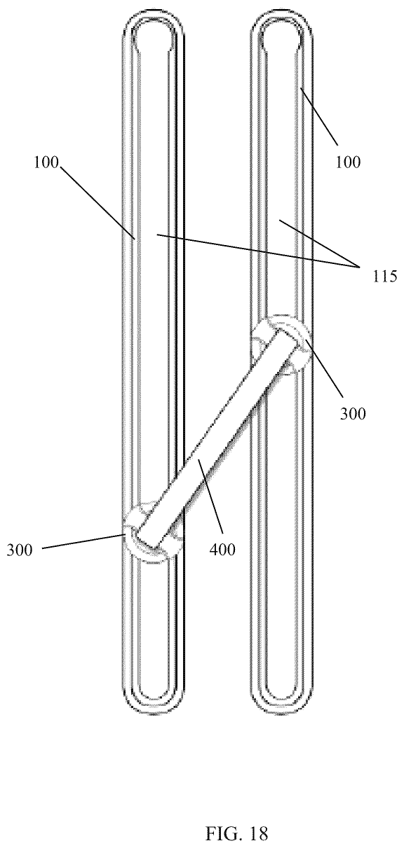

As shown in FIG. 16A, before squeezing the upper flanges 330, the spring 320 is extended, pushing the lower lateral extending portions 340 outward (via the lower inner walls 335) such that D1 is greater than W1. As shown in FIG. 16B, a user 700 can squeeze the upper flanges 330 into the indented spaces 350, causing the spring to compress (via the lower inner walls 335) and causing the lower lateral extending portions 340 to move towards each other. Once the distance D2 is less than W1, the CL module 300 can be lowered into the rail 110 at the desired opposing slots 120. As shown in FIG. 16C, the user 700 can release the upper flanges 330, allowing the spring 320 to push out the lower inner walls 335 and therefore cause the lower lateral extending portions 340 to move outward such that D1 is greater than W1 again, thereby locking the CL module 300 into the desired slot position (i.e., the desired opposing slots 120) via the lower lateral extending portions 340 being respectively inserted into the opposing slots 120. As shown in FIG. 16D, the handle 310 of the CL module 300 can be rotated (e.g., in a circumferential direction of the CL module 300). The handle 310 can rotate independently of other elements of the CL module 300, leaving the CL module 300 locked in the slot position while the handle 310 is rotated to a desired orientation for connection with a band 400 (see also, e.g., FIGS. 17 and 18).

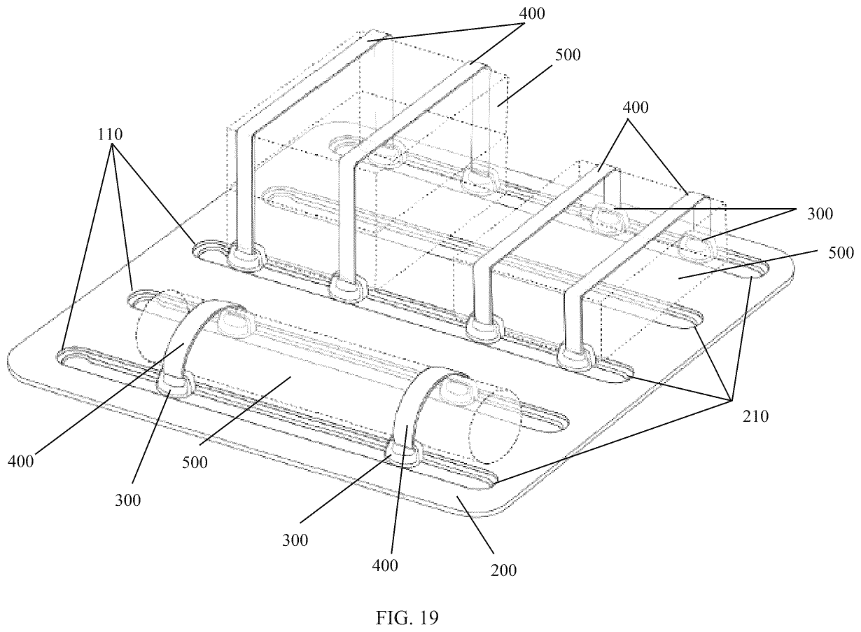

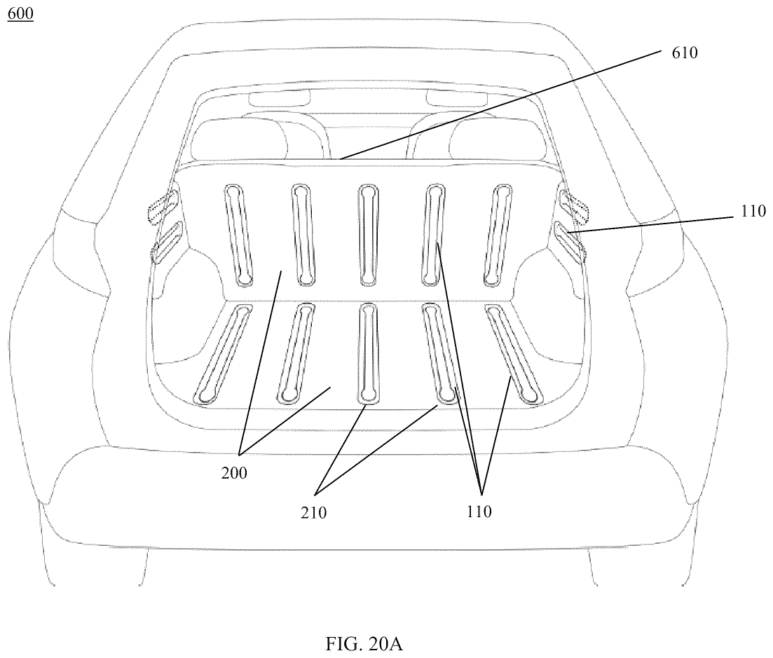

Referring to FIGS. 17 and 18, one or more bands 400 can be connected to CL modules 300 of the system, for example by removably fastening to the respective handles 310 of the CL modules 300. The bands 400 can be stretchable bands and can be made of any suitable material known in the art (e.g., can comprise an elastic material). This setup is similar to using bungee cords to connect to anchor points in the bed of a pickup truck, but in the modular cargo storage systems, the CL modules 300 serving as the equivalent of the anchor points are completely movable to any point (having a slot position within a rail) within the cargo area. Also, the handles 310 of the CL modules 300 can be rotated to any orientation to provide further customizability to the modular cargo storage system. FIG. 19 shows an example of CL modules 300 and bands 400 being used to hold various pieces of cargo 500 in place on a cargo load mat 200. The arrangement shown in FIG. 19 is just one example and, as discussed in detail herein, any arrangement can be used by adding/removing/relocating CL modules 300 and/or bands 400 (and/or rotating the handles 310 of the CL modules 300).

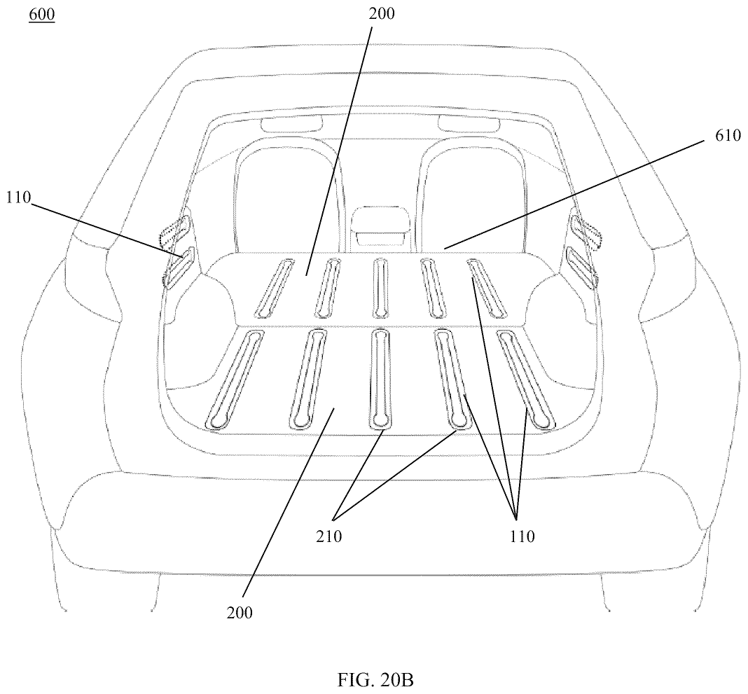

FIGS. 20A and 20B show rear views of a passenger vehicle 600 with the back hatch open and having a modular cargo storage system. The system includes a plurality of cargo load mats 200, including on the rear seat 610 and the sides of the cargo area. FIG. 20A shows the case where the rear seat 610 (e.g., to allow for more passenger space) is up, and FIG. 20B shows the case where the rear seat 610 is down (e.g., to allow for more cargo space). In either case, the cargo load mat 200 on the back of the rear seat 610 can be used for locating CL modules 300.

Embodiments of the subject invention provide cargo shelves and modular cargo shelf systems for passenger vehicles. The cargo shelf has two functional sides and can be combined with other cargo shelves to form a modular cargo shelf system. Users can change the orientation and quantity of cargo shelves used in the storage section of a passenger vehicle to get a desired arrangement, and the cargo shelves can also be used for sitting and/or setting objects outside of the passenger vehicle. Embodiments also provide methods of using (see, e.g., FIGS. 8A-12 and the accompanying description) and fabricating the cargo shelves and modular cargo shelf systems, as inherently described herein.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

When ranges are used herein, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

The subject invention includes, but is not limited to, the following exemplified embodiments.

Embodiment 1. A cargo shelf for a passenger vehicle, the cargo shelf comprising:

a first horizontal section;

a second horizontal section;

a third horizontal section;

a vertical section that is perpendicular or approximately perpendicular (e.g., at an angle in a range of from 850 to 950 with respect to each other) to the first horizontal section, the second horizontal section, and the third horizontal section, wherein the vertical section connects the first horizontal section and the second horizontal section; and

an angled section that is disposed at a first angle in a range of from 200 to 700 with respect to the first horizontal section, the second horizontal section, and the third horizontal section, wherein the angled section is disposed at a second angle in a range of from 200 to 700 with respect to the vertical section, and wherein the angled section connects the second horizontal section and the third horizontal section.

Embodiment 2. The cargo shelf according to embodiment 1, comprising a first side and a second side opposite to the first side,

wherein the first horizontal section comprises a first surface on the first side and a second surface opposite from the first surface and on the second side,

wherein the vertical section comprises a first surface on the first side and a second surface opposite from the first surface and on the second side,

wherein the second horizontal section comprises a first surface on the first side and a second surface opposite from the first surface and on the second side,

wherein the angled section comprises a first surface on the first side and a second surface opposite from the first surface and on the second side,

wherein the third horizontal section comprises a first surface on the first side and a second surface opposite from the first surface and on the second side, and

wherein the first side comprises at least one rail.

Embodiment 3. The cargo shelf according to embodiment 2, wherein the first side further comprises at least one hole, the at least one rail being respectively disposed in the at least one hole.

Embodiment 4. The cargo shelf according to any of embodiments 2-3, wherein the first surface of the first horizontal section comprises at least one rail, the first surface of the vertical section comprises at least one rail, the first surface of the second horizontal section comprises at least one rail, the first surface of the angled section comprises at least one rail, and/or the first surface of the third horizontal section comprises at least one rail.

Embodiment 5. The cargo shelf according to embodiment 4, wherein the first surface of the first horizontal section comprises at least one hole having at least one rail disposed therein, the first surface of the vertical section comprises at least one hole having at least one rail disposed therein, the first surface of the second horizontal section comprises at least one hole having at least one rail disposed therein, the first surface of the angled section comprises at least one hole having at least one rail disposed therein, and/or the first surface of the third horizontal section comprises at least one hole having at least one rail disposed therein.

Embodiment 6. The cargo shelf according to any of embodiments 2-5, wherein the first surface of the first horizontal section comprises exactly one rail, the first surface of the vertical section comprises exactly one rail, the first surface of the second horizontal section comprises exactly one rail, the first surface of the angled section comprises exactly one rail, and/or the first surface of the third horizontal section comprises exactly one rail.

Embodiment 7. The cargo shelf according to embodiment 6, wherein the first surface of the first horizontal section comprises exactly one hole having exactly one rail disposed therein, the first surface of the vertical section comprises exactly one hole having exactly one rail disposed therein, the first surface of the second horizontal section comprises exactly one hole having exactly one rail disposed therein, the first surface of the angled section comprises exactly one hole having exactly one rail disposed therein, and/or the first surface of the third horizontal section comprises exactly one hole having exactly one rail disposed therein.

Embodiment 8. The cargo shelf according to any of embodiments 2-7, wherein the second side comprises a cushion (e.g., made of soft and/or deformable material).

Embodiment 9. The cargo shelf according to embodiment 8, wherein the second surface of the first horizontal section, the second surface of the vertical section, the second surface of the second horizontal section, the second surface of the angled section, and/or the second surface of the third horizontal section comprises the cushion.

Embodiment 10. The cargo shelf according to any of embodiments 2-9, wherein each rail of the at least one rail is configured to have a CL module (as described herein; see also, e.g., FIGS. 16A-16D) removably inserted thereinto.

Embodiment 11. The cargo shelf according to any of embodiments 2-10, wherein at least two of the following are monolithically formed with each other: the first surface of the first horizontal section; the first surface of the vertical section; the first surface of the second horizontal section; the first surface of the angled section; and the first surface of the third horizontal section.

Embodiment 12. The cargo shelf according to any of embodiments 2-11, wherein at least two of the following are monolithically formed with each other: the second surface of the first horizontal section; the second surface of the vertical section; the second surface of the second horizontal section; the second surface of the angled section; and the second surface of the third horizontal section.

Embodiment 13. The cargo shelf according to any of embodiments 2-12, wherein at least two of the following are monolithically formed with each other: the first surface of the first horizontal section; the first surface of the vertical section; the first surface of the second horizontal section; the first surface of the angled section; the first surface of the third horizontal section; the second surface of the first horizontal section; the second surface of the vertical section; the second surface of the second horizontal section; the second surface of the angled section; and the second surface of the third horizontal section.

Embodiment 14. The cargo shelf according to any of embodiments 2-13, wherein the first side of the cargo shelf comprises a rubber material and/or a plastic material.

Embodiment 15. The cargo shelf according to any of embodiments 2-14, wherein the first side comprises at least one of: a first curved portion between the first surface of the first horizontal section and the first surface of the vertical section; a second curved portion between the first surface of the vertical section and the first surface of the second horizontal section; a third curved portion between the first surface of the second horizontal section and the first surface of the angled section; and a fourth curved portion between the first surface of the angled section and the first surface of the third horizontal section.

Embodiment 16. The cargo shelf according to embodiment 15, wherein the second side comprises at least one of: a first curved portion between the second surface of the first horizontal section and the second surface of the vertical section; a second curved portion between the second surface of the vertical section and the second surface of the second horizontal section; a third curved portion between the second surface of the second horizontal section and the second surface of the angled section; and a fourth curved portion between the second surface of the angled section and the second surface of the third horizontal section, and wherein a curvature of the first curved portion of the first side corresponds to that of the first curved portion of the second side, a curvature of the second curved portion of the first side corresponds to that of the second curved portion of the second side, a curvature of the third curved portion of the first side corresponds to that of the third curved portion of the second side, and/or a curvature of the fourth curved portion of the first side corresponds to that of the fourth curved portion of the second side.

Embodiment 17. The cargo shelf according to any of embodiments 2-15, wherein the second side comprises at least one of: a first curved portion between the second surface of the first horizontal section and the second surface of the vertical section; a second curved portion between the second surface of the vertical section and the second surface of the second horizontal section; a third curved portion between the second surface of the second horizontal section and the second surface of the angled section; and a fourth curved portion between the second surface of the angled section and the second surface of the third horizontal section.

Embodiment 18. The cargo shelf according to any of embodiments 1-17, further comprising a first handle at a first end of the cargo shelf and a second handle at a second end of the cargo shelf opposite from the first end.

Embodiment 19. The cargo shelf according to embodiment 18, wherein the first handle comprises a hole through the first horizontal surface, a first depressed section on a first surface of the first horizontal surface, and a second depressed section on a second surface of the first horizontal surface opposite from the first surface.

Embodiment 20. The cargo shelf according to any of embodiments 18-19, wherein the second handle comprises a hole through the third horizontal surface, a first depressed section on a first surface of the third horizontal surface, and a second depressed section on a second surface of the third horizontal surface opposite from the first surface.

Embodiment 21. The cargo shelf according to any of embodiments 1-20, wherein the first horizontal surface is disposed in a same plane as the third horizontal surface.

Embodiment 22. The cargo shelf according to any of embodiments 1-21, wherein the first angle is in a range of from 30° to 60°.

Embodiment 23. The cargo shelf according to any of embodiments 1-22, wherein the first angle is about 45°.

Embodiment 24. The cargo shelf according to any of embodiments 1-23, wherein the first angle is 45°.

Embodiment 25. The cargo shelf according to any of embodiments 1-24, wherein the second angle is in a range of from 30° to 60°.

Embodiment 26. The cargo shelf according to any of embodiments 1-25, wherein the second angle is about 45°.

Embodiment 27. The cargo shelf according to any of embodiments 1-26, wherein the second angle is 45°.

Embodiment 28. The cargo shelf according to any of embodiments 1-27, wherein an overall width of the cargo shelf is 97%-100% of a width of an interior of the passenger vehicle.

Embodiment 29. A modular cargo shelf system, comprising at least two cargo shelves, wherein each cargo shelf of the at least two cargo shelves is the cargo shelf according to any of embodiments 1-28.

Embodiment 30. The modular cargo shelf system according to embodiment 29, further comprising at least one CL module (as described herein; see also, e.g., FIGS. 16A-16D).

Embodiment 31. The modular cargo shelf system according any of embodiments 29-30, further comprising a cargo mat (as described herein; see also, e.g., FIGS. 17, 19, 20A, and 20B).

Embodiment 32. A passenger vehicle, comprising: at least one cargo shelf according to any of embodiments 1-28; and/or the modular cargo shelf system according to any of embodiments 29-31.

Embodiment 33. The passenger vehicle according to embodiment 32, wherein at least one CL module is connected to each of two sides of a rear storage section of the passenger vehicle, and wherein at least one cargo shelf is removably disposed on the CL modules connected to the two sides of the rear storage section.

Embodiment 34. The passenger vehicle according to any of embodiments 32-33, wherein at least one cargo shelf is removably disposed in a rear storage section of the passenger vehicle, in a configuration as shown in FIG. 9A, FIG. 9B, FIG. 9C, or FIG. 9D, and wherein each cargo shelf is removably disposed on at least one CL module on each side of the rear storage section.

Embodiment 35. The passenger vehicle according to any of embodiments 32-34, wherein the passenger vehicle is an electric vehicle.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A cargo shelf for a passenger vehicle, the cargo shelf comprising:
a first horizontal section;
a second horizontal section;
a third horizontal section;
a vertical section that is perpendicular or approximately perpendicular to the first horizontal section, the second horizontal section, and the third horizontal section, wherein the vertical section connects the first horizontal section and the second horizontal section; and
an angled section that is disposed at a first angle in a range of from 20° to 70° with respect to the first horizontal section, the second horizontal section, and the third horizontal section, wherein the angled section is disposed at a second angle in a range of from 20° to 70° with respect to the vertical section, and wherein the angled section connects the second horizontal section and the third horizontal section.

2. The cargo shelf according to claim 1, comprising a first side and a second side opposite to the first side,
wherein the first horizontal section comprises a first surface on the first side and a second surface opposite from the first surface and on the second side,
wherein the vertical section comprises a first surface on the first side and a second surface opposite from the first surface and on the second side,
wherein the second horizontal section comprises a first surface on the first side and a second surface opposite from the first surface and on the second side,
wherein the angled section comprises a first surface on the first side and a second surface opposite from the first surface and on the second side,
wherein the third horizontal section comprises a first surface on the first side and a second surface opposite from the first surface and on the second side, and
wherein the first side comprises at least one rail.

3. The cargo shelf according to claim 2, wherein the first side further comprises at least one hole, the at least one rail being respectively disposed in the at least one hole.

4. The cargo shelf according to claim 2, wherein the first surface of the first horizontal section comprises at least one rail, the first surface of the vertical section comprises at least one rail, the first surface of the second horizontal section comprises at least one rail, the first surface of the angled section comprises at least one rail, and the first surface of the third horizontal section comprises at least one rail.

5. The cargo shelf according to claim 2, wherein the first surface of the first horizontal section comprises exactly one rail, the first surface of the vertical section comprises exactly one rail, the first surface of the second horizontal section comprises exactly one rail, the first surface of the angled section comprises exactly one rail, and the first surface of the third horizontal section comprises exactly one rail.

6. The cargo shelf according to claim 2, wherein the second side comprises a cushion,
wherein the second surface of the second horizontal section and the second surface of the angled section comprises the cushion.

7. The cargo shelf according to claim 2, wherein each rail of the at least one rail is configured to have a click and lock module removably inserted thereinto.

8. The cargo shelf according to claim 2, wherein the first surface of the first horizontal section, the first surface of the vertical section, the first surface of the second horizontal section, the first surface of the angled section, and the first surface of the third horizontal section are monolithically formed with each other.

9. The cargo shelf according to claim 2, wherein the second surface of the first horizontal section, the second surface of the vertical section, the second surface of the second horizontal section, the second surface of the angled section, and the second surface of the third horizontal section are monolithically formed with each other.

10. The cargo shelf according to claim 2, wherein the first side of the cargo shelf comprises at least one of a rubber material and a plastic material.

11. The cargo shelf according to claim 1, further comprising a first handle at a first end of the cargo shelf and a second handle at a second end of the cargo shelf opposite from the first end.

12. The cargo shelf according to claim 11, wherein the first handle comprises a hole through the first horizontal surface, a first depressed section on a first surface of the first horizontal surface, and a second depressed section on a second surface of the first horizontal surface opposite from the first surface.

13. The cargo shelf according to claim 11, wherein the second handle comprises a hole through the third horizontal surface, a first depressed section on a first surface of the third horizontal surface, and a second depressed section on a second surface of the third horizontal surface opposite from the first surface.

14. The cargo shelf according to claim 1, wherein the first horizontal surface is disposed in a same plane as the third horizontal surface.

15. The cargo shelf according to claim 1, wherein the first angle is in a range of from 30° to 60°, and wherein the second angle is in a range of from 30° to 60°.

16. The cargo shelf according to claim 1, wherein the first angle is about 45°, and
wherein the second angle is about 45°.

17. A modular cargo shelf system, comprising:
at least two cargo shelves, wherein each cargo shelf of the at least two cargo shelves is the cargo shelf according to claim 1;
at least one click and lock module; and
a cargo mat comprising at least one rail configured to receive the at least one click and lock module.

18. A passenger vehicle, comprising the modular cargo shelf system present in a rear storage section of the passenger vehicle.

19. The passenger vehicle according to claim 18, wherein the passenger vehicle is an electric vehicle.

20. A cargo shelf for a passenger vehicle, the cargo shelf comprising:
a first horizontal section;
a second horizontal section;
a third horizontal section;
a vertical section that is perpendicular or approximately perpendicular to the first horizontal section, the second horizontal section, and the third horizontal section, wherein the vertical section connects the first horizontal section and the second horizontal section; and
an angled section that is disposed at a first angle in a range of from 30° to 60° with respect to the first horizontal section, the second horizontal section, and the third horizontal section, wherein the angled section is disposed at a second angle in a range of from 30° to 60° with respect to the vertical section, and wherein the angled section connects the second horizontal section and the third horizontal section.
wherein the cargo shelf comprises a first side and a second side opposite to the first side,
wherein the first horizontal section comprises a first surface on the first side and a second surface opposite from the first surface and on the second side,
wherein the vertical section comprises a first surface on the first side and a second surface opposite from the first surface and on the second side,
wherein the second horizontal section comprises a first surface on the first side and a second surface opposite from the first surface and on the second side,
wherein the angled section comprises a first surface on the first side and a second surface opposite from the first surface and on the second side,
wherein the third horizontal section comprises a first surface on the first side and a second surface opposite from the first surface and on the second side,
wherein the first surface of the first horizontal section comprises exactly one rail, the first surface of the vertical section comprises exactly one rail, the first surface of the second horizontal section comprises exactly one rail, the first surface of the angled section comprises exactly one rail, and the first surface of the third horizontal section comprises exactly one rail,
wherein each rail is configured to have a click and lock module removably inserted thereinto,
wherein the second side comprises a cushion,
wherein the second surface of the second horizontal section and the second surface of the angled section comprises the cushion,
wherein each rail is configured to have a click and lock module removably inserted thereinto,
wherein the first surface of the first horizontal section, the first surface of the vertical section, the first surface of the second horizontal section, the first surface of the angled section, and the first surface of the third horizontal section are monolithically formed with each other,
wherein the second surface of the first horizontal section, the second surface of the vertical section, the second surface of the second horizontal section, the second surface of the angled section, and the second surface of the third horizontal section are monolithically formed with each other,
wherein the cargo shelf further comprises a first handle at a first end of the cargo shelf and a second handle at a second end of the cargo shelf opposite from the first end,
wherein the first handle comprises a hole through the first horizontal surface, a first depressed section on the first surface of the first horizontal surface, and a second depressed section on the second surface of the first horizontal surface,
wherein the second handle comprises a hole through the third horizontal surface, a first depressed section on the first surface of the third horizontal surface, and a second depressed section on the second surface of the third horizontal surface, and
wherein the first horizontal surface is disposed in a same plane as the third horizontal surface.
